(19) United States
(12) Patent Application Publication
(10) Pub. No.: US 2004/0211443 A1
(43) Pub. Date: Oct. 28, 2004

(54) Magnetic plug detector

(75) Inventors: Burney J. Latiolais JR., Lafayette, LA (US); Braxton I. Moody V, Lafayette, LA (US); Keith T. Lutgring, Lafayette, LA (US); Donald E. Mosing, Lafayette, LA (US)

Correspondence Address: John D. Jeter, 1403 Teche Drive, St. Martinville, LA, 70582, US

(73) Assignee: FRANK'S CASING CREW AND RENTAL TOOLS, INC., LAFAYETTE, LA (US)

(21) Appl. No.: 10/102,224

(22) Filed: Mar. 19, 2002

(51) Int. Cl. B08B 9/055

(52) U.S. Cl. 134/8; 15/104.063

(57) ABSTRACT

A magnetic anomaly detector at a selected location on a pipe string detects the passing of a pig carrying a permanent magnet. To distinguish between a number of pigs, the magnets are differently oriented, in terms of which magnetic pole passes the detector first. To distinguish between a number of magnet carrying pigs, the magnets are oriented such that a planned series of field changes occur in preferred order for each pig passing the detector.

This invention pertains to means to detect the movement of a plug, or pig, moving along a pipe bore. Additionally, it pertains to distinguishing between different plugs passing a reference point by sensing the different nature of the magnetic characteristics of the plugs.

### BACKGROUND

In the art, and as interpreted herein, pipeline plugs move vertically and pipeline pigs move horizontally, but in general they are physically identical. The term pig and plug will be used interchangably herein.

Most petroleum well drilling activity involves casing strings cemented in place in the earth. The cement is often moved, as a slurry, down the well in the bore of a pipe string. Often, a working pipe string is used to extend an installation pipe string down to the location for cementing. After cementing, the working string is detached from the installed string and recovered. It is important that the cement goes where intended and nowhere else. Flow control is essential when pumping cement down pipe string bores.

When pipe strings are cemented into wells, the well and the pipe string suspended down the well are initially full of fluid, usually drilling fluid. A plug, usually of resilient material, is installed in the bore of the suspended pipe string and cement is pumped into the bore, pushing the plug and the initial fluid ahead of the advancing cement slurry. When the required amount of cement slurry has been pumped into the pipe bore, another plug is installed in the pipe bore. A different fluid, a driving or displacement fluid, is then pumped into the pipe bore to push the second plug, and the cement charge, along the pipe bore.

When the second plug gets to the bottom of the well, the cement has been pushed upward along the annulus between the new pipe string and the earthen wall of the well bore.

If either plug fails to move into and along the pipe string bore at the appropriate time, a bad cementing job can result. There is no way to see the plug inside the pipe.

There is a need for a reliable, and reasonably simple, system for detecting the movement of the plugs past critical points in the pipe arrangement.

### SUMMARY OF INVENTION

It is a purpose of this invention to provide means to detect specially prepared plugs moving in pipe string bores.

It is another object of this invention to provide plugs, or pigs, with magnets and to provide stationary means to detect such pigs moving in pipe bores.

It is yet another object of the invention to provide pigs with different magnet in polarity distributions and to provide means to distinguish between such different plugs.

These and other objects, advantages, and features of this invention will be apparent to those skilled in the art from a consideration of this specification, including the attached claims and appended drawings.

A special plug, or pig, is prepared for movement along a conventional pipe bore. The plug is usually made of elastomeric material, with a rigid core of material that can readily be drilled up after it serves the intended purpose.

To make the plug detectable it is fitted with one or more magnets, either attached to the outside surfaces or imbedded in the plug material. For small bore pipe with thick walls, the core of the plug, usually of non-metallic material is used to embed a magnet. For use with large plugs used in pipe with thinner walls, small magnets can be attached to the outside surface of the plug for successful and reliable detection as it moves along a pipe bore.

To distinguish between a first and a second plug. The magnets are simply oriented differently. To distinguish each plug from a larger plurality of plugs, combinations of magnetic orientations are employed.

The needed detection equipment already exists. The device preferred is used to detect the end of coiled tube moving along a pipe bore. End detection is important if coiled tubing is being used to service a well under pressure. If the tube is pulled out of all blowout preventers, a well is out of control. If the end of the tube is detected, however, a lower blowout preventer can be closed to avoid problems when the tubing is finally extracted and leaves the top blowout preventer open. In that application, a light weight steel tube is detected within the bore of much heavier pipe.

Magnetic detection usually takes one of three forms; 1. detection of a disturbance in an established magnetic field by the passage of the article being detected; 2. detection of a magnetic field caused by the passage of the article being detected; and 3. change in the magnetic permeability, in the area selected for detection, as a result of the presence of an article being detected.

To maximize the ability to detect the presence of substances capable of influencing the magnetic field of an area, a magnetic field is often generated to permeate the area of interest. By that process, stray, or spurious magnetic fields have less influence. If the detection sensitivity alone is amplified, movement of unrelated iron products in the area can cause errors. Apparatus of this invention can utilize any existing detector system that is usable with the novel pigs but the magnetic field producing units are preferred.

Existing magnetic field characteristic detectors, when used with the plugs of this invention, produce an output signal that moves an indicator first in one direction if a magnet passes the detection area north pole first. It first moves in the other direction if a plug of this invention passes the detection area south pole first. A different reaction, providing the same selectivity, is accomplished by placing a ring of bar magnets around the periphery of the plug, each magnet having a particular pole directed radially outward. The second plug is distinguishable if the magnets are oriented with the other poles directed radially outward.

Combinations of magnet orientations provide detectable characteristics enabling the distinguishing of any plug from a collection of different plugs.

### BRIEF DESCRIPTION OF DRAWINGS

FIGS. 1A and 1B are side views, coextensive, showing a vertical plane of earth, having a symbolic well with casing and a well pipe string suspended therein.

FIG. 2 is a side view, mostly in cut-away, of a detector station on a pipe string, with a typical plug, or pig, passing along a pipe bore.

FIG. 3 is a side view, mostly in cut-away, of a detector station with plugs passing in series, with plug distinguishing features.

FIG. 4 is similar to FIG. 3 with plugs of different distinguishing features in position for series detection.

FIG. 5 is similar to FIG. 3 with plugs having further distinguishing features in series in a pipe bore.

### DETAILED DESCRIPTION OF DRAWINGS

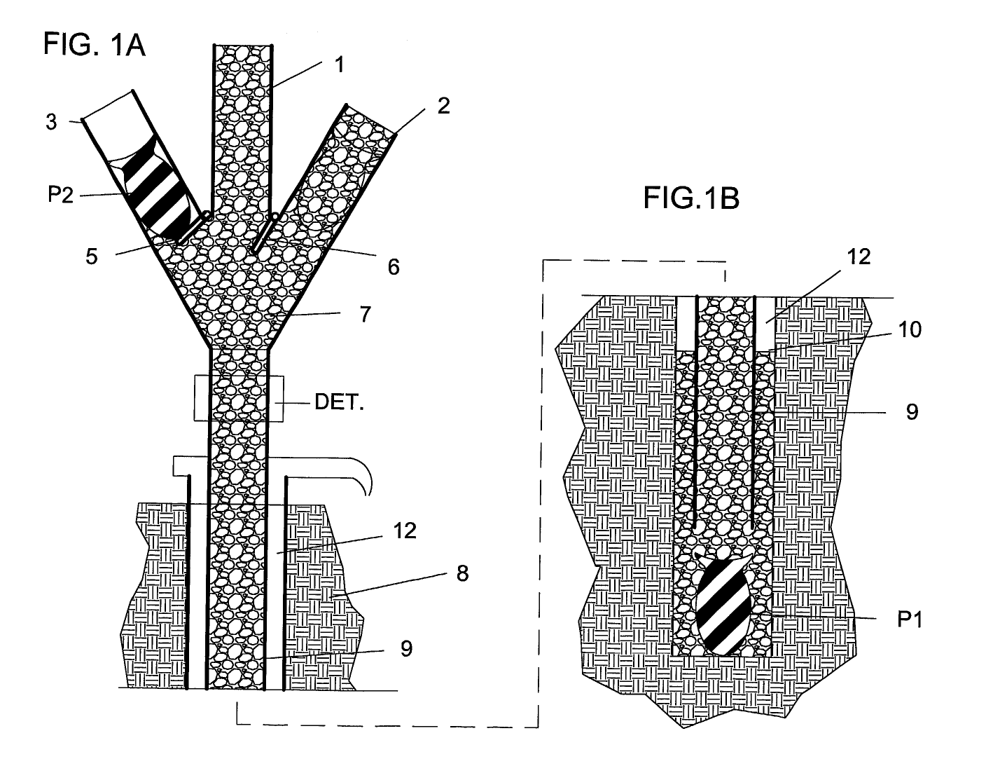

FIG. 1 is a schematic presentation of a section of earth containing a well with surface casing SC installed and conducting a pipe string 9 into the well. Symbolic surface connections include two plug magazines, 2 and 3, arranged to drop plugs by release actions of control 5 and 6, on cue of the operators. Plug P1 is already dropped and has preceded a cement column to the bottom of the well. The pipe string is filled with cement which has pushed plug P1 out the bottom of the casing string. Cement is flowing back up annulus 12. When the prescribed amount of cement has been pumped into the pipe extension 1 plug control 5 will be activated to release plug P2 from magazine 3 into the pipe string. A forcing fluid, usually drilling mud, will follow plug P2 until plug P2 is pushed out the bottom of the casing string 9.

Excepting the use of the detector DET. of this invention, this figure could represent prior art.

This schematic is intended to be an oversimplification of the actual processes and machinery involved. It does provide background for the points of novelty of this invention.

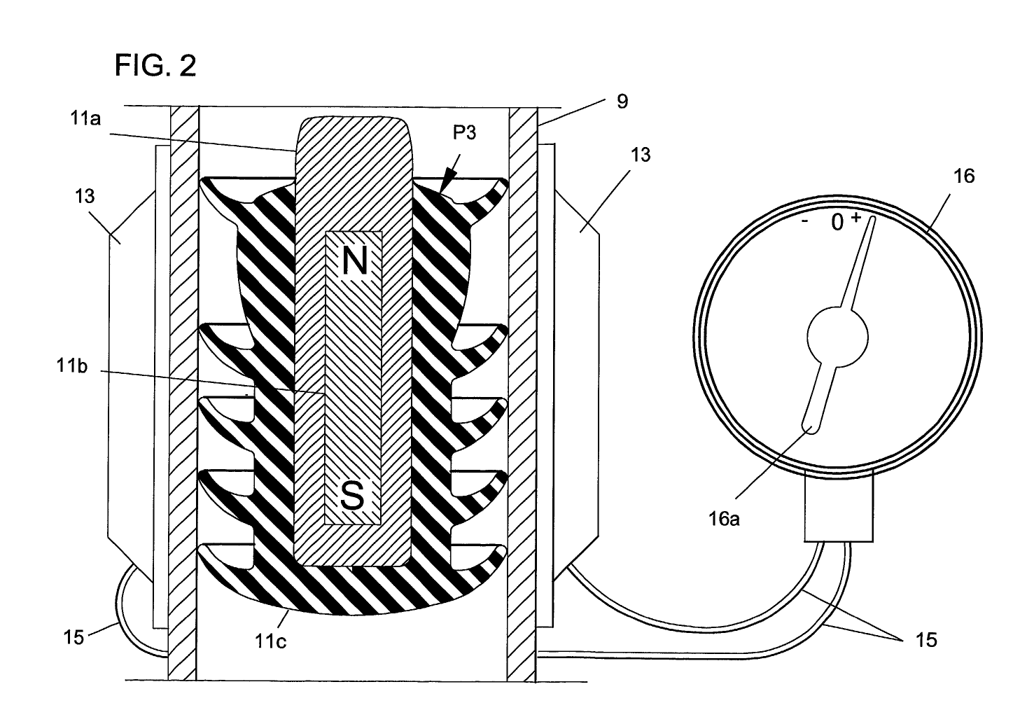

FIG. 2 shows a pipe 9 supporting sensor pack 13 wired by leads 15 to indicator 16 to detect plug 11 carrying magnet 11b in core 11a as plug P3 passes the sensor while moving through the pipe bore. The plug comprises radially extending elastomer mass 11c configured to occlude the bore but pass through easily.

When one end of the magnet reaches the plug sensing members 13, the needle 16a on indicator 16 first swings one direction, plus in this instant, then swings in the opposite direction when the positive pole passes the detector. If the plug remains the same otherwise, and the magnet is turned around to advance the north pole through the sensor region first, the needle 16a on the dial 16 first swings toward the negative side before reversing movement.

That sequence of movements, and the differences between response to different pigs passage, represents the signal characteristics that can be used to distinguish between pigs.

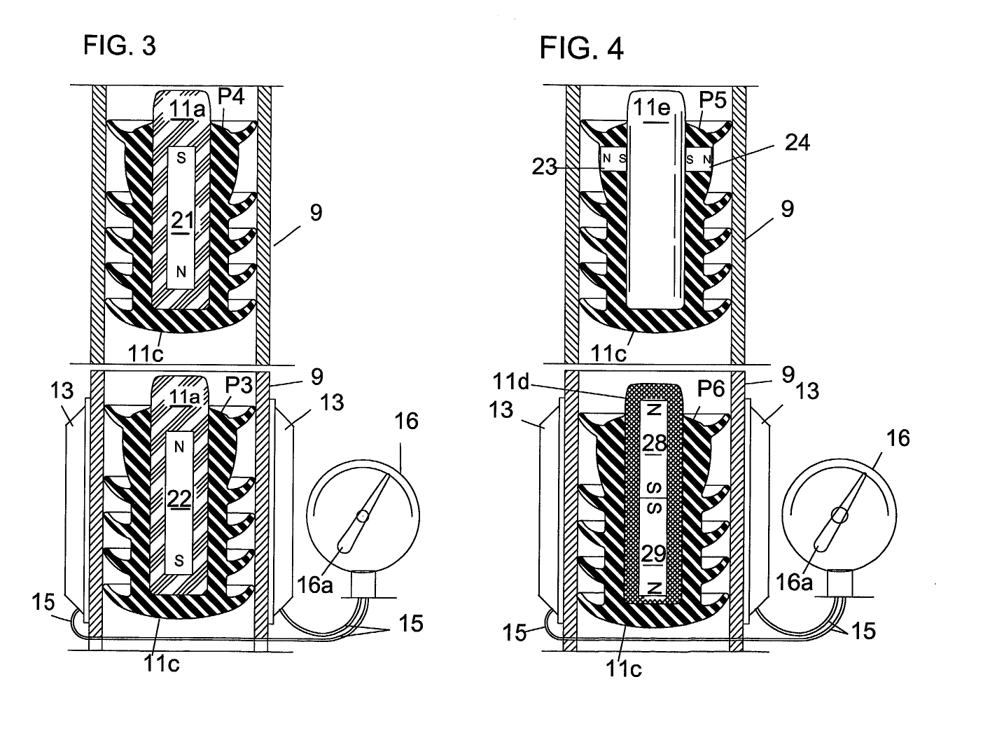

FIGS. 3, 4, and 5 are of similar layout, showing plugs in series moving through the bore of pipe 9. The plug components differ and have different captions. Plugs and pigs move in pipe bores with the extreme ends of salient members lagging, due to dragging on the pipe bore wall. All plugs shown are moving or prepared to move downward.

The magnet core 22 of plug P4 in FIG. 3 moves South pole first through the sensor field of detector element 13. Needle 16a swings first in one direction, then swings to the other direction as the North pole moves through the detector field. When the plug P3, with core 21, moves through the detector field the needle will swing first in the direction opposite the one experienced with core 22, and will then switch to the opposite side of zero as the trailing magnetic pole moves through the detector field.

The operation is simple and the indication clear enough for direct observation to make it unnecessary to provide more sophisticated instrumentation. The signal that drives the dial readout shown, however, can be supplied to processing circuits to drive chart recorders, digital recorders, or other storage and indicator devices, if preferred. As defined herein an output signal from the detector is construed to be a signal adapted to the purpose. Such is well within the scope of those skilled in the art of instrumentation. That is anticipated by and is within the scope of the claims.

The plugs of FIG. 4 are distinguishable from either plug of FIG. 3. Magnets 28 and 29 in one core lid yield a detector signal with a double excursion as the plug moves through the detector. The plug P5, with core 11e and magnets 23 and 24, with north poles outward causes a slowly rising south pole response, a quick north pole indication and a trailing off of a south pole indication. The four plugs of FIGS. 3 and 4 can be distinguished if fed through the detector field in any order at reasonably similar velocities.

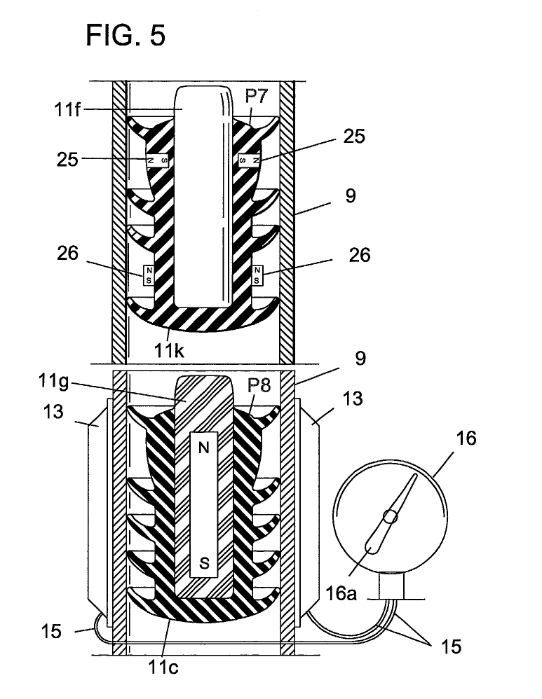

FIG. 5 shows a modified plug P7, with magnets 25 and 26 oriented to yield a more complex movement display of indicator 16a. Core 11f is usually a drillable or crushable material. Elastomer portion 11k has been modified by removal of a salient ring to make room for magnets 26. Magnets 25 are imbedded in the plug. Strap-on magnets such as 26 make possible several combinations of magnetic characteristics to be used on plugs that are otherwise similar, and can be stocked on-site in quantity. Plug P8 is similar to plug P3.

From the foregoing, it will be seen that this invention is one well adapted to attain all of the ends and objects hereinabove set forth, together with other advantages which are obvious and which are inherent to the apparatus.

It will be understood that certain features and sub-combinations are of utility and may be employed without reference to other features and sub-combinations. This is contemplated by and is within the scope of the claims.

As many possible embodiments may be made of the apparatus of this invention without departing from the scope thereof, it is to be understood that all matter herein set forth or shown in the accompanying drawings is to be interpreted as illustrative and not in a limiting sense.

The invention having been described, we claim:

1. A pipeline pig characteristic detecting apparatus for determining when a pig passes a selected location, and determining which pig, of a selection of pigs, passes the selected location, the apparatus comprising:
a) a pipe string, along the bore of which pigs can pass;
b) at least two pigs, having distinguishably different identifiable characteristics when the pigs are within the bore of the pipe string.
c) a magnetic field change detector means operable form outside the pipe string to indicate when a pig carrying a selected array of magnets passes a selected location and to indicate which pig passed;
d) an indicator means to output a signal when one of the pigs passes, the signal having a characteristic identifiable with the identifiable characteristic of the pig.

2. The apparatus of claim 1 wherein said distinguishably different identifiable characteristics are provided by selective orientation of the poles of magnets carried by the pigs.

3. The apparatus of claim 2 wherein at least one said magnet is embedded in the material comprising the pig.

4. The apparatus of claim 2 wherein at least one of the magnets is secured to the outer surface of the pig.

5. The apparatus of claim 1 wherein said distinguishably different identifiable characteristics is the pigs influence on an existing magnetic field.

6. The apparatus of claim 1 wherein said distinguishably different identifiable characteristics comprises a magnetic field caused by said pig.

7. The apparatus of claim 1 wherein said distinguishably different identifiable characteristics comprises the magnetic permeality nature of the pig.

8. A pipeline pig characteristic detecting apparatus for determining when a pig passes a selected location, and determining which pig, of a selection of pigs, passes the selected location, the apparatus comprising:
a) a pipe string, along the bore of which pigs can pass;
b) a plurality of pigs, each pig having an axis of symmetry with a fore end and an aft end;
c) a plurality of permanent magnets, at least one magnet carried by a first of said pigs, the magnet arranged to proceed north pole forward when the first pig moves along a pipe bore;
d) a second of said pigs arranged to carry at least one of said magnets, the magnet arranged to proceed south pole forward when the second pig moves along a pipe bore; and
e) a magnetic field change detector, having a detection range, situated to respond when one of said pigs moves through the detection range of the detector, and to produce an output signal when a pig is detected.

9. The apparatus of claim 8 wherein said output signal indicates whether a south pole or a north pole reaches the detection range of the detector first.

10. The apparatus of claim 8 wherein said signal indicates which magnet arrangement passed the detector whereby the pig situated with that magnet arrangement can be distinguised from other pigs.

11. A method for use with pigs moving along the bore of a pipe string to isolate selected bodies of fluid between at least two pigs distributed axially along the bore and to ascertain which of the pigs pass a selected pig detecting region of the pipe string, according to the steps:
a) placing permanent magnets on the pigs to be used;
b) orienting the magnets on a first pig such that a selected magnetic pole will be the first pole to pass a selected plane on the pipe string when the first pig is moving along the pipe bore;
c) orienting the magnets on a second pig such that the opposite magnetic pole, compared with said first pig, will be the first pole to pass the selected plane when the second pig is moving along the pipe string bore;
d) placing a detector such that it can detect changes in the magnetic field in the vicinity of the detector when one of the pigs passes the detector, and produce an output signal bearing distinguishing information relative to which pig passed the selected plane; and
e) passing the pigs along the pipe string bore.
